(19) United States
(12) Patent Application Publication
(10) Pub. No.: US 2005/0225998 A1
(43) Pub. Date: Oct. 13, 2005

(54) Light for vehicles

(76) Inventor: Shigeru Komori, Shinagawa-ku (JP)

Correspondence Address: Shigeru Komori, 18-6 Ohi 2-chome, Shinagawa-ku, 140-0014, JP

(21) Appl. No.: 10/821,704

(22) Filed: Apr. 9, 2004

(51) Int. Cl. F21V 19/00

(52) U.S. Cl. 362/519; 362/507; 362/538; 362/464; 362/465; 362/518

(57) ABSTRACT

The light for vehicle includes a light body, having an opening for outputting light, arranging at least one light source thereinto; a light cover, having a shape and size which cover the opening of the light body 4; and a reflective layer, having a detailed concave-convex structure surface formed in an inner surface of the light body. Therefore, it can fully demonstrate the function of a light during lighting and have the depth and a uniform and quality appearance during lighting in daytime and turning off the light, and it allows people who watch the light to not give dazzle strong when they see the strong reflected light from the front of the light

### FIELD OF THE INVENTION

The present invention relates to a light for vehicles which gives change to how in a light to be visible and mitigates the strong dazzle of reflected light.

### BACKGROUND OF THE INVENTION

In the conventional light for vehicles such as motor cycles and cars, since the reflected light is gathered at the reflective surface formed in the shape of flat and smooth mirror surface and is reflected, the strong reflected light is irradiated to the forward direction by combining with the light source of high luminosity, and the driver can get a bright field of view.

Therefore, since the conventional light for vehicles is illuminated by such intense reflected light that an eye will feel dizzy for a moment when the light of a reflector is seen, it could not see directly at all.

### SUMMARY OF THE INVENTION

Accordingly, it is an object of the present invention to provide a light for vehicle which can fully demonstrate the function of a light during lighting and have the depth and a uniform and quality appearance during lighting in daytime and turning off the light.

Moreover, it is another object of the present invention to provide a light for vehicle which allow people who watch the light to not give dazzle strong when they see the strong reflected light from the front of the light.

Furthermore, it is further object of the present invention to provide a light for vehicle which can tell an oncoming car, a passing person, etc. about existence efficiently, and cautions can be urged to it.

The present invention is understood to encompass embodiments which include all or only a portion of the above objects, features and advantages which, unless recited in claims defining the invention, are understood not to limit interpretation of such claims. The above, and other objects, features and advantages of the present invention will become apparent from the following description read in conjunction with the accompanying drawings, in which like reference numerals designate the same elements.

It is to be expressly understood, however, that the drawings are for the purpose of illustration and description only, and are not intended as a definition of the limits of the invention.

### BRIEF DESCRIPTION OF THE DRAWINGS

FIG. 1 is a front view showing a first embodiment of the present invention;

FIG. 2 is a side view;

FIG. 3 is a cross sectional view taken along the line 3-3 of FIG. 2;

FIG. 4 is a schematic explanation view;

FIG. 5 is a side view showing a second embodiment of the present invention;

FIG. 6 is a cross sectional view taken along the line 6-6 of FIG. 5;

FIG. 7 is a side view showing a third embodiment of the present invention;

FIG. 8 is a cross sectional view taken along the line 8-8 of FIG. 7;

FIG. 9 is a side view showing a fourth embodiment of the present invention;

FIG. 10 is a cross sectional view taken along the line 9-9 of FIG. 9;

FIG. 11 is a side view showing a fifth embodiment of the present invention;

FIG. 12 is a cross sectional view taken along the line 12-12 of FIG. 11;

FIG. 13 is a side view showing a fifth embodiment of the present invention;

FIG. 14 is a cross sectional view taken along the line 14-14 of FIG. 13;

FIG. 15 is a side view showing a sixth embodiment of the present invention;

FIG. 16 is a cross sectional view taken along the line 16-16 of FIG. 15;

FIG. 17 is a side view showing a seventh embodiment of the present invention;

FIG. 18 is a cross sectional view taken along the line 18-18 of FIG. 17;

FIG. 19 is a side view showing an eighth embodiment of the present invention;

FIG. 20 is a cross sectional view taken along the line 20-20 of FIG. 19;

FIG. 21 is a side view showing a ninth embodiment of the present invention;

FIG. 22 is a cross sectional view taken along the line 22-22 of FIG. 21;

FIG. 23 is a side view showing a tenth embodiment of the present invention;

FIG. 24 is a cross sectional view taken along the line 24-24 of FIG. 23;

FIG. 25 is a side view showing an eleventh embodiment of the present invention; and

FIG. 26 is a cross sectional view taken along the line 26-26 of FIG. 25.

### DETAILED DESCRIPTION OF THE PREFERRED EMBODIMENTS

Preferred embodiments of the present invention are described in more detail below referring to the accompanying drawings.

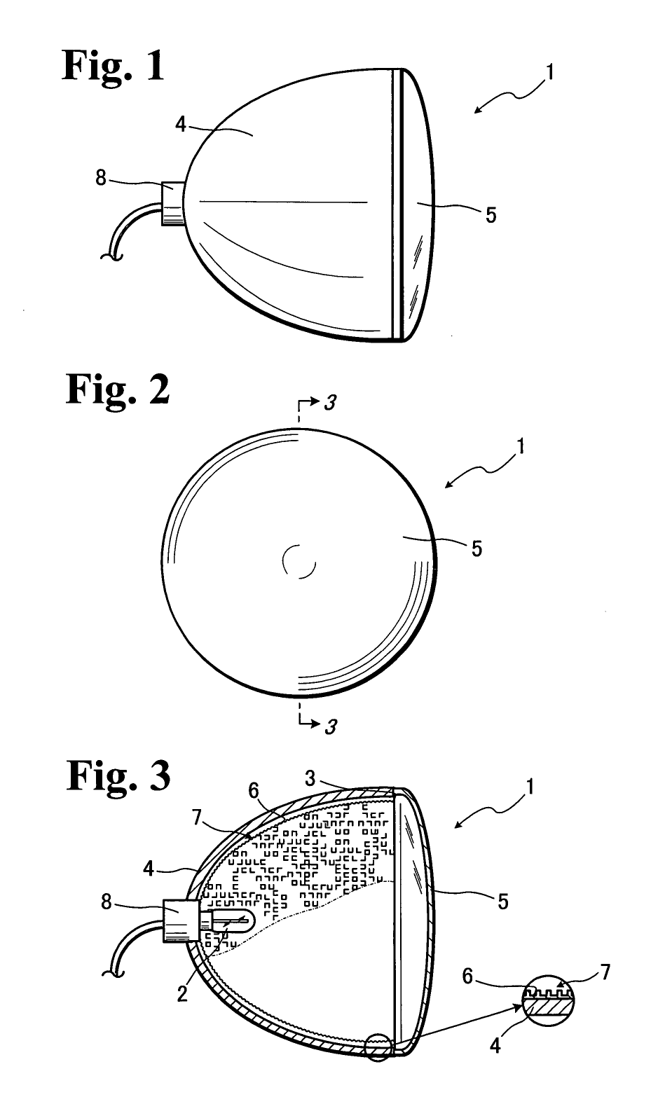

An understanding of the present invention may be best gained by reference FIGS. 1 to 4. The numeral 1 shows a light for vehicle of the present invention and comprises a light body 4, having an opening 3 for outputting light, arranged at least one light source 2; a light cover 5 made of resin materials, having light transmittance state, such as acrylic material, polycarbonate resin and the like, having a shape and size which cover the opening 3 of the light body 4; and a reflective layer 7, having a detailed concave-convex structure surface 6 formed in an inner surface of the light body 4, capable of collecting light of the light source 2 and emitting the reflected light from the opening 3.

The light body 4 is cast by metal material, resin material or the like, and the light source 2 (valve) with a predetermined brightness is inserted in a socket 8.

The light cover 5 covers the opening 3 of the light cover 4, it has same size and shape with corresponding to the size and shape of the light body 4. It may be formed in the shape of a rectangle, square, circular, and it may be formed in the shape of a L character modification pattern.

In addition, the light cover 5 may be colored by hue when needed. Moreover, it may be used a coloring light and covered the colored cap on the light source 2 instead of coloring the cover.

Moreover, the light cover 5 is made of resin materials having light transmittance state in this embodiment, and it may be made of inorganic materials such as glass and the like.

In the reflective layer 7 of this embodiment, the concave-convex pattern is given beforehand to the metallic mold for molding, and it is cast by carrying out pattern transfer from the metallic mold at a forming object (light body) at the stage of molding. Moreover, it may be replaced with use of the metallic mold and may press the metal plate.

The form of the concave-convex structure surface 6 of the reflective layer 7 may be formed in the shape of a stripe, dot, triangle, quadrangle, lattice form, checkered pattern, etc.

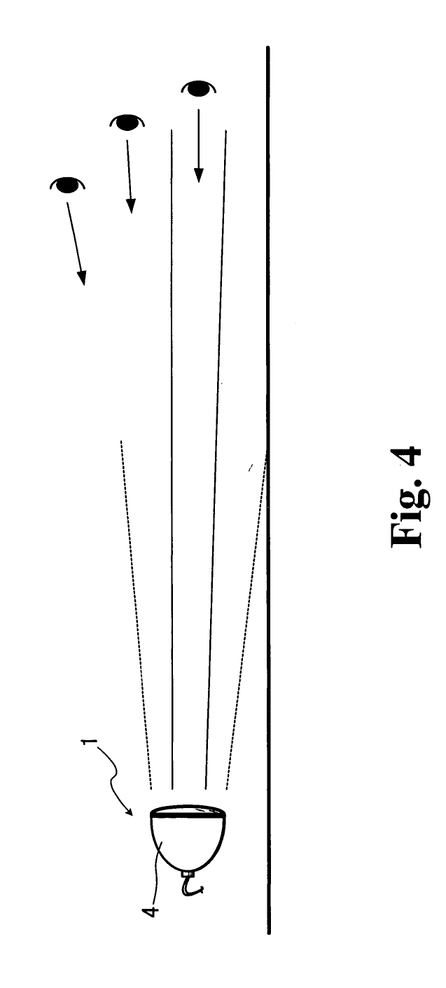

As shown in FIG. 4, in the light 1 for vehicle, the reflective layer 7 can be colored by the radiated light of back side of the light source, and the effective white light can be irradiated by the front side of a light source to the forward direction. Therefore, according to change of the degree of incidence angle of light or change of an observer's visual angle, the valuable and outstanding appearance can be taken.

A prism phenomenon arises according to the concave-convex structure surface 6 of the reflective layer 7, the light angle is changed, and the light which came out of the light source 2 is emitted from the light cover 5. The distributed action of the light according to the incidence angle of incidence light is effected, and light is divided into various rainbow colors and changes to coloring light. This coloring light changes a round striped pattern in the reflective layer 7. In this way, the coloring light which changes to the different continuation spectrum shape from the conventional white reflection light acts as a light of the reflective layer which is not dazzling.

Moreover, when the observers see the light body 4, the emphasized appearance having the depth is achieved according to a prism phenomenon, and the high quality of appearance is achieved.

Furthermore, when the concave-convex structure surface 6 is watched from across during lighting, the light source 2 shines with seven colors and there is no dazzle. Therefore, the completely new appearance is achieved. Such effects have the same function about the visibility of the direction light installed at the corner part of the vehicle.

In addition, the concave-convex pattern may be given to the inner surface (side of the light source) of the light cover 5 in this embodiment. According to a concave-convex pattern, the functions as a lens object and recursive reflective can be obtained. The concave-convex pattern gives to the metallic mold for example, and it can be transferred to the forming object (light cover) from the metallic mold at the stage of molding.

Moreover, the light of the present invention may be used for one light of the lights of two lights or three lights types.

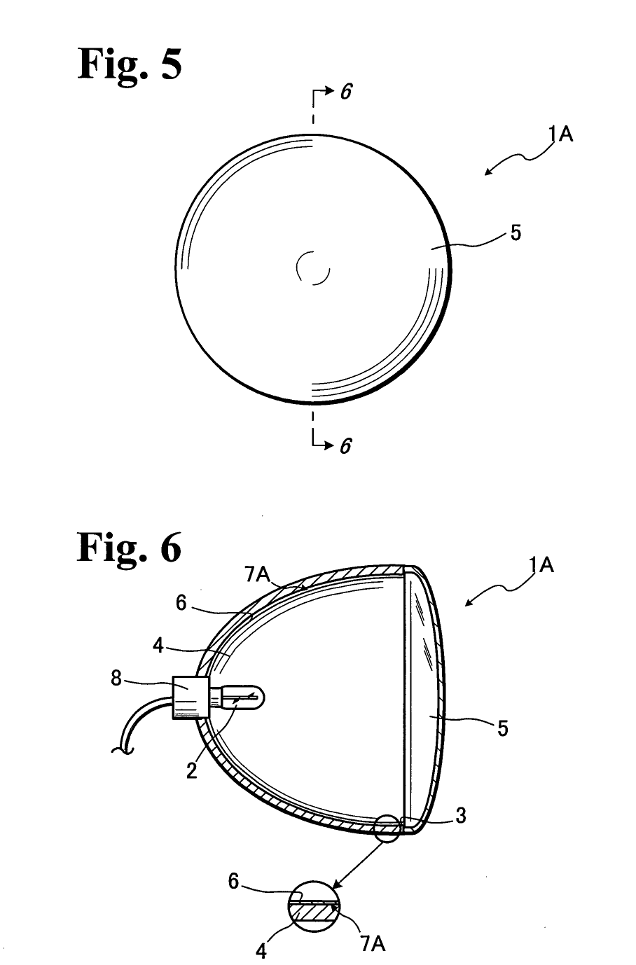

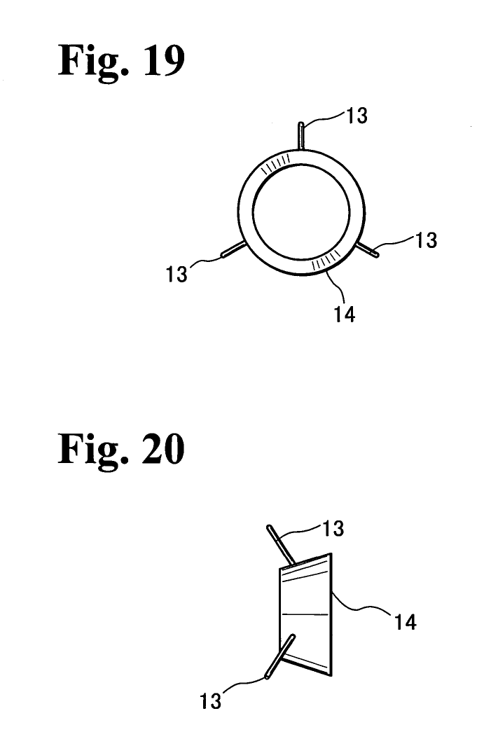

Other embodiments of the present invention will now be described with reference to FIGS. 5-26. In FIGS. 5-26, the same components as in the first embodiment described above with reference to FIGS. 5-26 are designated by the same reference numerals and therefore will not be further explained in great detail.

A second embodiment of the present invention is shown in FIGS. 5-6. It is distinguished from the first embodiment in that a polarizing film 7A as a reflective layer is attached at the inner surface of the light body 4. Therefore, a light 1A for vehicle according to the second embodiment has similar advantages to that according to the first embodiment.

In addition, the polarizing film 7A may have the patterns of a stripe, dot, triangle, quadrangle, lattice form, checkered pattern, etc. Also it is possible to change how to adhere and arrange so that the variety of patterns for the reflected light can be selected.

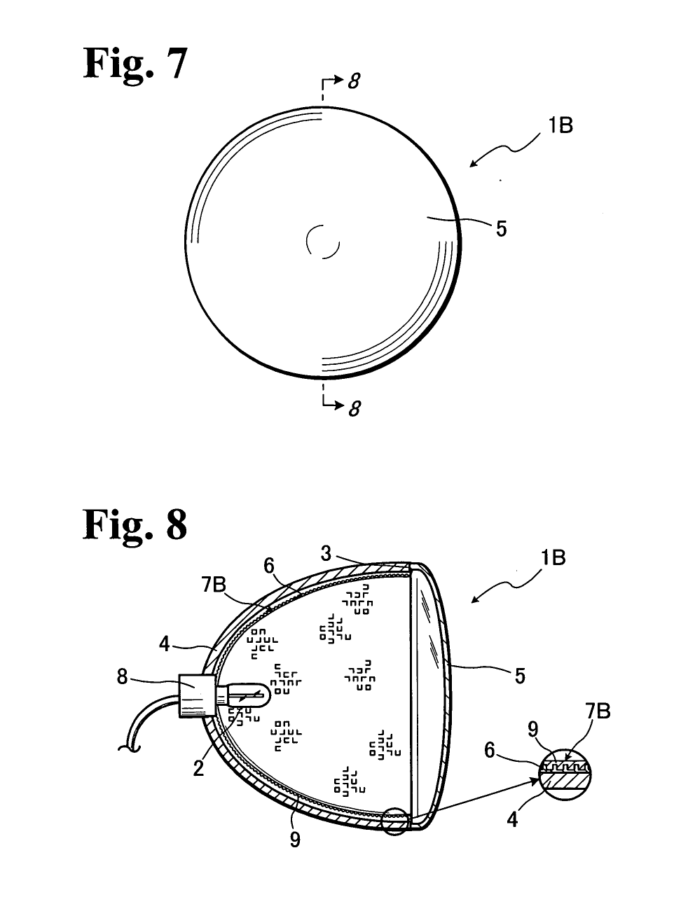

A third embodiment of the present invention is shown in FIGS. 7-8. It is distinguished from the first embodiment in that a reflective layer 7B includes a protection layer 9 which covers the concave-convex structure surface 6 and protects the surface 6. Therefore, a light 1B for vehicle according to the third embodiment has similar advantages to that according to the first embodiment.

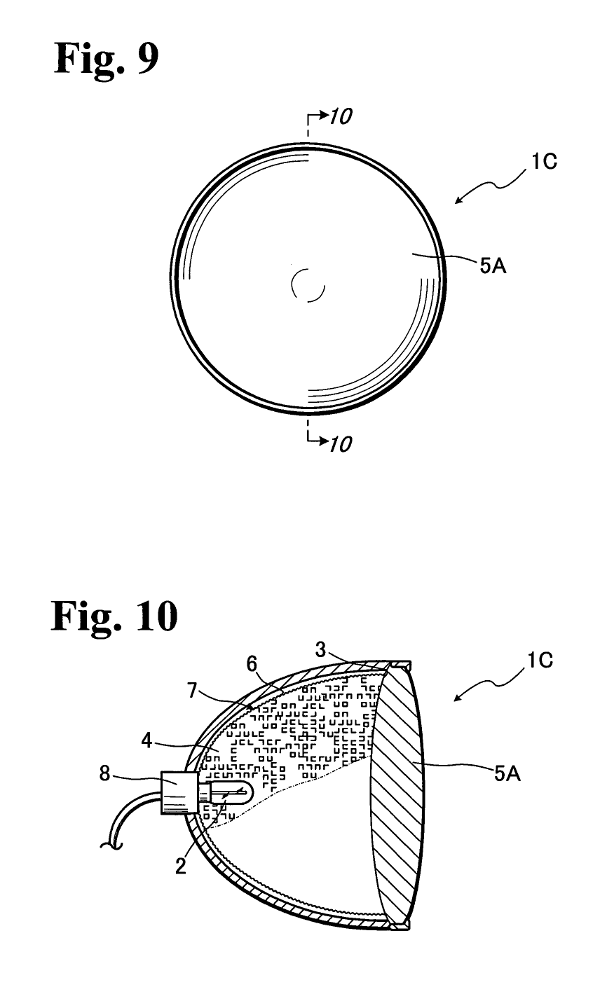

A fourth embodiment of the present invention is shown in FIGS. 9-10. It is distinguished from the first embodiment in that a light cover 5A is formed in the shape of a parabolic lens. Therefore, a light 1C for vehicle according to the fourth embodiment has similar advantages to that according to the first embodiment.

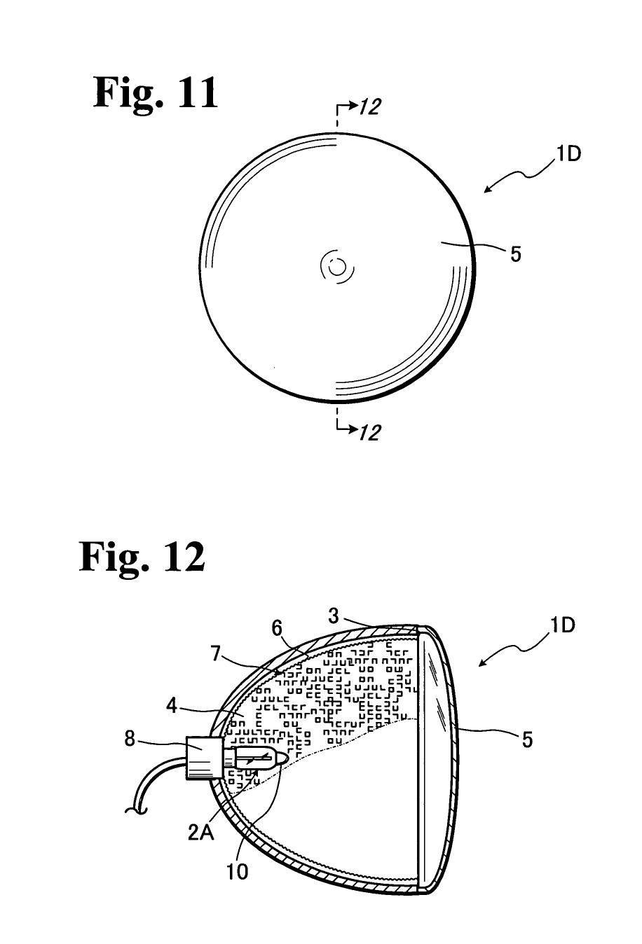

A fifth embodiment of the present invention is shown in FIGS. 11-12. It is distinguished from the first embodiment in that a valve 2A as a light source has a projected lens 10 provided at a tip portion thereof. Therefore, a light 1D for vehicle according to the fifth embodiment has similar advantages to that according to the first embodiment, and since the convex lens 10 condenses the front output light at the parallel state, it can illuminate near, and it can irradiate light to a long distance.

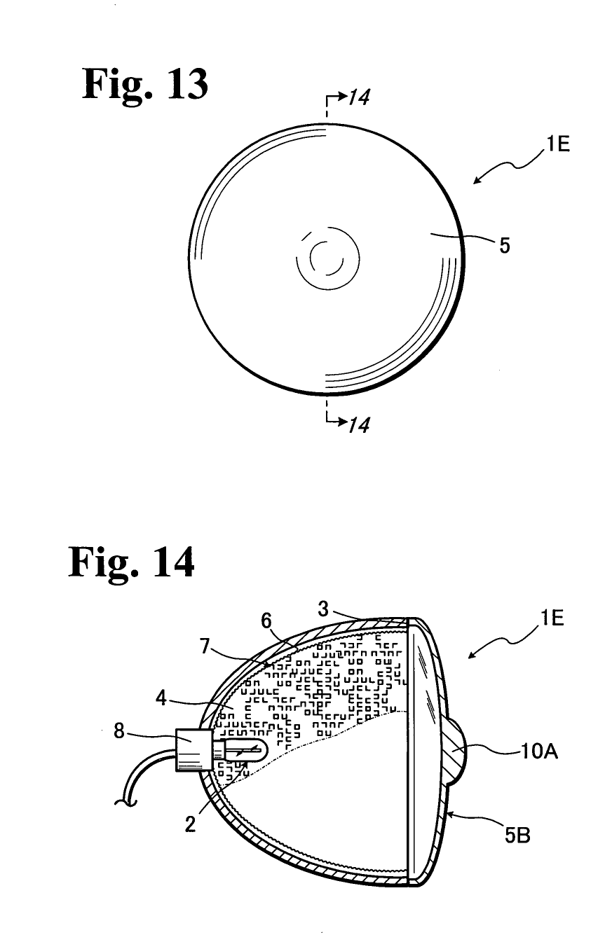

A sixth embodiment of the present invention is shown in FIGS. 13-14. It is distinguished from the first embodiment in that a light cover 5B has a projected lens 10A provided at a front portion thereof. Therefore, a light 1E for vehicle according to the sixth embodiment has similar advantages to that according to the first embodiment, and since the light cover 5B adjusts the distance with the light source and is set to a comfortable position, the condensing efficiency including the amount of light can be improved, and the width of irradiation light can be expanded, and irradiation distance can be extended more.

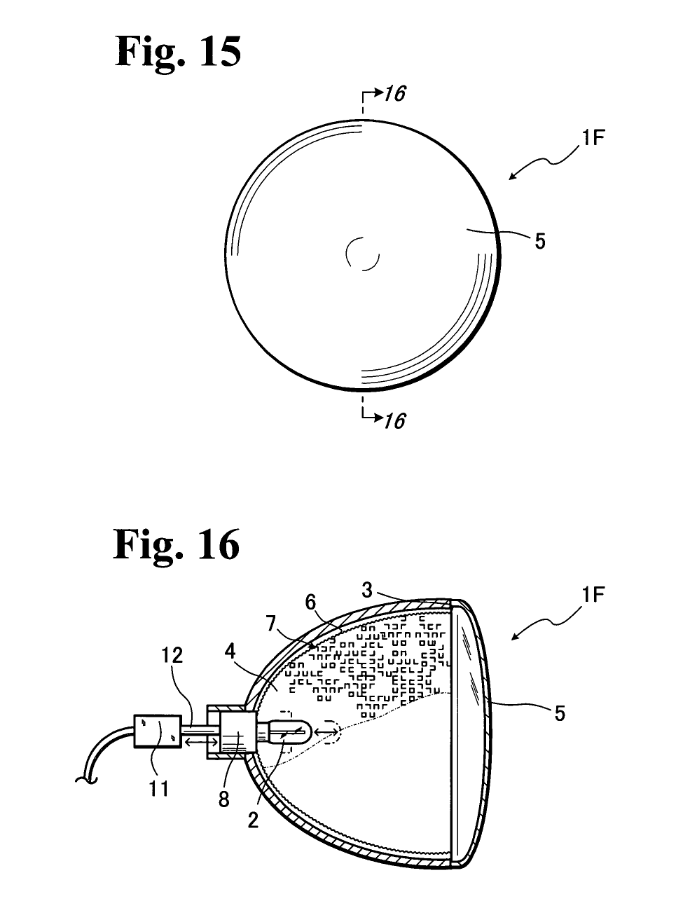

A seventh embodiment of the present invention is shown in FIGS. 15-16. It is distinguished from the first embodiment in that the socket 8 and light source 2 are attached to a support part 12 which is provided in conjunction with the controller 11, controlling so as to move to the forward and backward directions. Therefore, a light 1F for vehicle according to the seventh embodiment has similar advantages to that according to the first embodiment. When the light source 2 moves to the backward direction, the reflective layer 7 reflects white light, and the irradiation light is condensed and illuminates a long distance. On the other hand, when it pushes out to the forward direction, the reflective layer 7 colors, and the irradiation light may spread and may be illuminated near. Therefore, when the light source 2 is moved forward and backward within the reflective layer and it change the position of the distributed action, since spectrum may color according to the position of the light source 2, and it can control coloring.

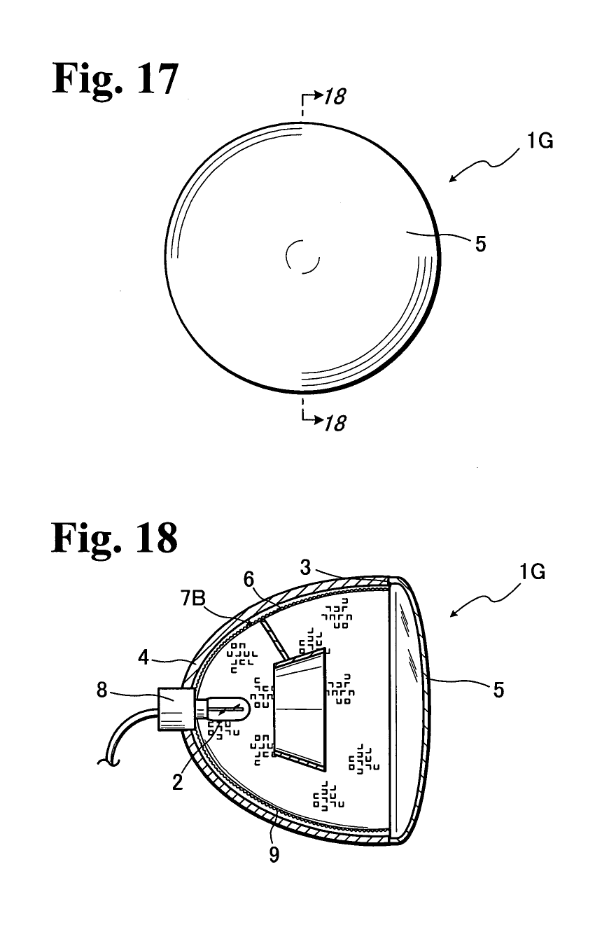

An eighth embodiment of the present invention is shown in FIGS. 17-20. It is distinguished from the third embodiment in that a reflective part 14 formed in the shape of a lamp shade, having legs 13, 13, 13, is attached fixedly to the inner surface of the light body 4 adjacent the light source. Therefore, a light 1G for vehicle according to the seventh embodiment has similar advantages to that according to the third embodiment, and since the light 1G can condense radiation from a light source 2, the amount of light increases, and a stronger irradiation light can be achieved

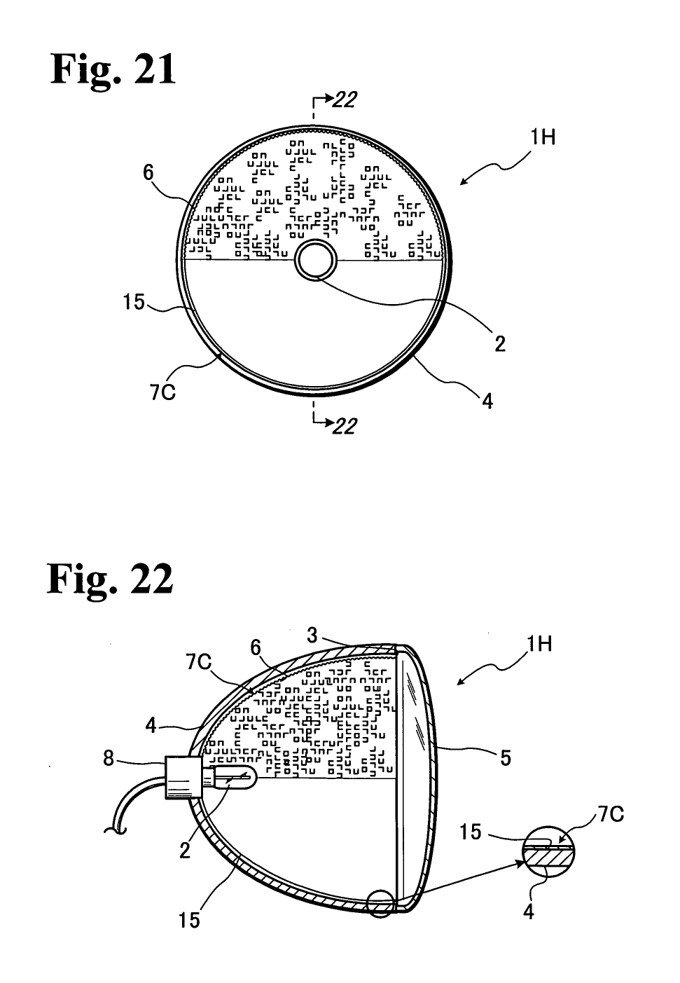

A ninth embodiment of the present invention is shown in FIGS. 21-22. It is distinguished from the first embodiment in that a reflective layer 7C includes the concave-convex structure surface 6 and a non- structure surface 6 as a plane surface selectively. Therefore, a light 1H for vehicle according to the ninth embodiment has similar advantages to that according to the first embodiment

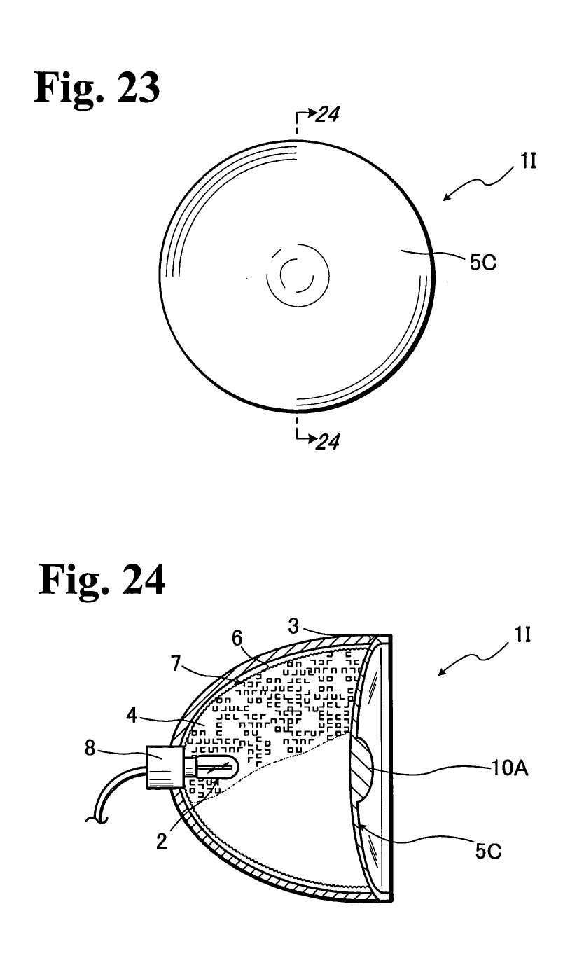

A tenth embodiment of the present invention is shown in FIGS. 23-24. It is distinguished from the sixth embodiment in that a light cover 5C is formed in the shape of a concave. Therefore, a light 1I for vehicle according to the tenth embodiment has similar advantages to that according to the sixth embodiment.

An eleventh embodiment of the present invention is shown in FIGS. 25-26. It is distinguished from the first embodiment in that the controller 11 is replaced from another controller 11A which includes a relay 16, capable of applying the current intermittently and a switch 17 switching the current to the relay 16. Therefore, a light 1J for vehicle according to the eleventh embodiment has similar advantages to that according to the first embodiment. Moreover, since the reflected light can be switched easily from the lighting state to the blinking state, it can be used according to a traffic situation.

In addition, the vehicle light having one light is explained in the present invention, and the light having a plurality of vehicle lights such as two, three lights and so on may be used.

Moreover, the light which is used for the headlight part of vehicles is explained in each embodiment, and the light which is used for sub-light, side light, back light, indoor light and the like.

Furthermore, although each embodiment differs mainly explained based on the first embodiment, when the composition used for each embodiment uses the present invention is combined, the same effect is achieved.

As set forth above, the advantages of the invention are as follows:

(1) The light for vehicle includes a light body, having an opening for outputting light, arranging at least one light source thereinto; a light cover, having a shape and size which cover the opening of the light body 4; and a reflective layer, having a detailed concave-convex structure surface formed in an inner surface of the light body. Therefore, it can fully demonstrate the function of a light during lighting and have the depth and a uniform and quality appearance during lighting in daytime and turning off the light.

(2) As discussed above, the light of the present invention can be completed by only adding the simple improvement for the common light, and if required, various appearances are easily realizable.

(3) As discussed above, since the detailed concave-convex structure surface is formed in the inner surface of the light cover, while the colored reflected light controls strong dazzle according to the conventional white reflected light, and the front irradiation of the white light can be performed.

(4) As discussed above, the reflective surface colors like ring of seven colors such as red, blue, yellow and the like vividly so that its appearance is also beautiful, and it is practical.

(5) Also claim 3 has the same effect as the above (1) to (4), for using the light source which has the convex lens, it can control strong dazzle caused by the conventional white reflected light and irradiate the nearby place. Also the irradiation distance can be developed with a front white irradiation light.

(6) Also claims 4-14 have the same effects as the above (1) to (4).

1. A light for vehicle comprising:
a light body, having an opening for outputting light, arranging at least one light source thereinto;
a light cover, having a shape and size which cover the opening of the light body 4; and
a reflective layer, having a detailed concave-convex structure surface formed in an inner surface of the light body.

2. A light for vehicle according to claim 1, wherein at least one light source is turned downward below the horizontal line and arranged.

3. A light for vehicle according to claim 1, wherein at least one light source has a projected lens provided at a top portion thereof.

4. A light for vehicle according to claim 1, wherein the light cover has one of a projected lens provided at a top portion thereof and a parabolic lens.

5. A light for vehicle, further comprising:
a reflective part attached to inner circumferential part, adjacent the light source, of the light cover, reflecting the light which goes straight in full.

6. A light for vehicle according to claim 1, wherein at least one light source is attached to a support part which may move to the forward and backward directions

7. A light for vehicle according to claim 1, wherein the reflective layer includes a concave-convex structure surface and a non-structure surface as a pattern.

8. A light for vehicle according to claim 1, wherein the reflective layer is a polarizing film having a concave-convex structure surface, forming inside the light body.

9. A light for vehicle according to claim 1, wherein the reflective layer is a polarizing film having a concave-convex structure surface and a non-structure surface as a pattern, forming inside the light body.

10. A light for vehicle according to claim 1, wherein the reflective layer is processed a concave-convex structure surface as a pattern, forming inside the light body.

11. A light for vehicle according to claim 1, wherein the reflective layer is processed a concave-convex structure surface and a non-structure surface as a pattern, forming inside the light body.

12. A light for vehicle according to claim 1, wherein the reflective layer is formed in the shape of one of a stripe, a dot, a lattice form, checkered pattern and combined patterns thereof.

13. A light for vehicle according to claim 1, wherein the light cover is colored.

14. A light for vehicle comprising:
a light body, having an opening for outputting light, arranging at least one light source thereinto;
a light cover, having a shape and size which cover the opening of the light body 4;
a reflective layer, having a detailed concave-convex structure surface formed in an inner surface of the light body; and
a controller such as power source switch including a relay, capable of applying the current intermittently and a switch switching the current to the relay.
